(19) United States
(12) Patent Application Publication
(10) Pub. No.: US 2006/0219372 A1
(43) Pub. Date: Oct. 5, 2006

(54) Side window roll-up shade with movable shaft

(75) Inventor: Melf Hansen, Gondelsheim (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: BOS GmbH & Co. KG, Ostfildern (DE)

(21) Appl. No.: 11/387,273

(22) Filed: Mar. 23, 2006

(30) Foreign Application Priority Data
Mar. 29, 2005 (DE) 102005014670.8-42

(51) Int. Cl. B60J 1/20

(52) U.S. Cl. 160/370.22

(57) ABSTRACT

A side window roll-up shade for a passenger car has bearing arrangement on both ends. One of the two bearing arrangements is provided with a threaded stem that extends over only a short distance of the wind-up shaft and which is anchored either in the wind-up shaft or the car body. Therefore, the assembly is limited to those parts responsible for axial movement on the associated wind-up shaft end.

### BACKGROUND OF THE INVENTION

With known car bodies, the B-column often extends at an angle different from 90° relative to the bottom edge of the rear side window with the adjacent window edge also extending at that angle. When such a side window is equipped with a roll-up shade, a portion of the roll-up shade corresponds approximately to the surface of the side window that is approximated by straight edges. Due to the slope of the forward window edge, there is a visible light gap between the window edge and the adjacent roll-up shade that changes when retracting and extending the shade. Such an arrangement is not desirable because this light gap is directly in the field of view of the rear passengers.

To prevent the light gap, it is preferred that the front edge of the roll-up shade always remain a small distance from the front edge of the window regardless of how much the shade has been extended. This can be achieved by using wind-up shafts that perform a combined translational and rotational movement. When the roll-up shade rotates, the wind-up shaft generally moves in sync with the window edge. This synchronized translational movement is generated by threads.

There are several known ways in which to generate this translational movement, however, all are relatively complicated to install. This is a problem especially with side window roll-up shades in which the spring motor is equipped with a continuous spring rod as a counter bearing. In such cases, an extension of the spring rod is provided with threads in order to generate the translational movement. This arrangement is very sensitive to vibrations and can lead to rattling noises with certain types of vehicle vibrations.

### BRIEF SUMMARY OF THE INVENTION

In view of the foregoing, a general object of the present invention is to create a side window roll-up shade that is easier to install. The side window roll-up shade of the invention can include a wind-up shaft that is rotatably supported by first and second wind-up shaft bearing arrangements. The two wind-up shaft bearing arrangements permit a rotational and a translational movement of the wind-up shaft.

To generate the translational movement, either the first or the second wind-up shaft bearing arrangement is provided with a threaded stem and a threaded bore that sits on the threaded stem. The threaded stem is located only in the area of the associated wind-up shaft bearing arrangement and guides into the wind-up shaft only by a distance corresponding to the stroke of the wind-up shaft plus the minimum thread overlap. The threaded stem projects into the wind-up shaft only by a short distance, i.e., either with its threaded part or a short anchor section. In each case, the anchor section is arranged at a short distance opposite the wind-up shaft. In particular, an optional threaded bar is not used as the bearing journal. Therefore, the wind-up shaft remains essentially empty and at most contains the spring motor, if a spring motor arranged outside the wind-up shaft (e.g., in the shape of a spiral spring is not used.

An arrangement that saves a great deal of space is achieved when the wind-up shaft is tubular and a coil spring that forms the active part of a spring motor is housed in the shaft. The coil spring is preferable anchored with its inner end on the wind-up shaft and its outer end on the associated wind-up shaft bearing arrangement. In this way, the interior of the coil spring can remain completely free, which greatly assists in preventing rattling noises.

According to one embodiment, the first wind-up shaft bearing arrangement can have a bearing journal that is fixed in place and immovable in the vehicle. The outer end of the coil spring of the spring motor can be anchored to this bearing journal. The bearing journal of the wind-up shaft bearing arrangement to which the coil spring is anchored can be the threaded stem with which the axial movement is controlled. In such a case, the bearing journal of the other wind-up shaft bearing arrangement can be smooth.

The threaded stem for each wind-up shaft bearing arrangement can also be housed in which the spring motor is not anchored. Such an arrangement could be somewhat easier to install. In particular, such arrangement can allow selectively producing a side-window roll-up shade with an axially movable wind-up shaft moving by eliminating the threaded stem or a side-window roll-up shade that is not axially movable. In the latter case, the threaded stem can be locked in rotation with the wind-up shaft while the threaded bore is housed in a stationary bearing plate. Alternatively, the threaded stem can sit in the bearing plate and the corresponding bore in the wind-up shaft.

The support of the wind-up shaft on the side with the threaded stem can be improved if a smooth, cylindrical pin, which interacts with a correspondingly smooth cylindrical bore is coaxial to the threaded stem. In such an arrangement, the radial forces are taken up essentially by the smooth, cylindrical part.

According to another aspect of the invention, a side-window roll-up shade arrangement is provided that can be selectively configured without changing the bearing plate or the wind-up shaft, so that during the rotational movement the wind-up shaft either moves axially or remains in place. This side-window roll-up shade includes a relatively short threaded stem that can be inserted either into the associated bearing plate or the wind-up shaft, for example, by means of a catch connection, in order to generate the axial movement. If the threaded stem is not joined during assembly, the wind-up shaft remains in place in the axial direction. The biasing of the spring motor is used for this purpose, for example. The tension spring provided is intended to bias the wind-up shaft into its end position elastically.

### BRIEF DESCRIPTION OF THE SEVERAL VIEWS OF THE DRAWING(S)

FIG. 1 is a cut away, schematic perspective view of the rear area of an illustrative passenger car having a side-window roll-up shade according to the invention.

FIG. 2 is a schematic front view of the side-window roll-up shade of FIG. 1.

FIG. 3 is a partially exploded perspective view of the forward wind-up shaft bearing arrangement of the side-window roll-up shade of FIG. 1.

FIG. 4, the a partially exploded, cut away perspective view of the rear wind-up shaft bearing arrangement of the window roll-up shaft of FIG. 1.

FIG. 5 is an exploded, longitudinal section view of an alternative embodiment of the wind-up shaft bearing arrangement with threaded stem.

### DETAILED DESCRIPTION OF THE INVENTION

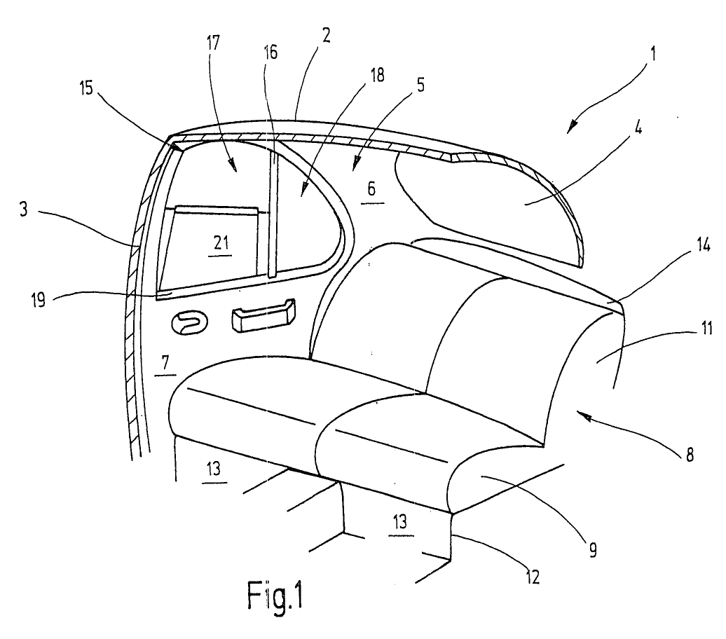

FIG. 1 illustrates the rear area of a passenger car. The view in FIG. 1 is towards the right inner side, which is the mirror image of the left inner side. The drawing is simplified. Thus, for example, interior car body structures, such as bracing and attachment elements, are not shown because their illustration is not required for understanding the invention. Likewise, the representation of the car body is schematic and the hollow spaces provided therein are not shown.

The illustrated car body section 1 has a roof 2 from which a B-column 3 is guided downwards to a floor assembly. A corresponding B-column is on the opposite side of the vehicle. The B-columns are inclined, so that their top end is shifted towards the back of the vehicle. The roof 2 transitions into a rear window at its rear edge. At the side, the rear window ends at a C-column 5, which is located a distance from the B-column 3. The C-column 5 supports an inner lining 6. Between the B-column 3 and the C-column 6, a rear right side door 7 is hinged in a known way to the B-column. A rear seat bank 8 is at the level of the rear right side door 7, which includes a sitting surface 9 and also a backrest 11. The sitting surface 9 lies on a base surface 12 that is part of the floor assembly, and foot spaces 13 are formed in front of this base. A rear-seat shelf 15 extends to the bottom edge of the rear window 4 at the level of the top edge of the backrest 11.

In the typical sedan configuration, the rear right side door 7 is provided with a side window 15. The side window 15 is divided into a substantially rectangular window pane 17 and also a generally triangular window pane 18 by a generally vertical brace 16. At the bottom end, the two panes 17 and 18 are bordered by a windowsill 19. The windowsill 19 runs at an angle less than 90° to a front window edge 20. The panel in the window pane 17 is movable up and down in a known way, wherein it is guided, among other things, in the vertical brace 16. The window pane 17 can be selectively shaded by an associated roll-up shade 21 that can be drawn out from the interior of the door 7 through a slot in the windowsill 19. The drive mechanism for the roll-up shade 21 is located in the interior of the door 7 underneath the windowsill 19.

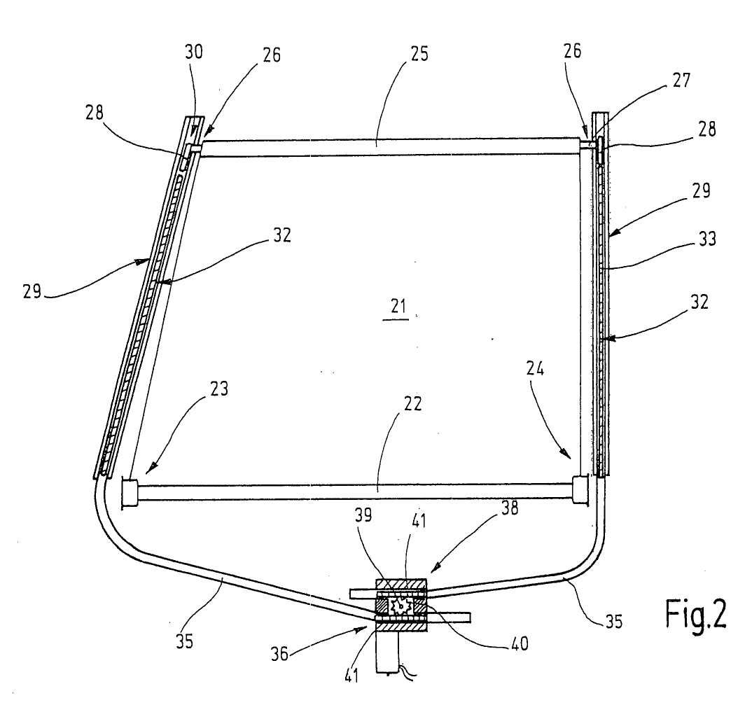

FIG. 2 illustrates the components associated with driving, guiding, or storing, in the unused state, the roll-up shade 21. The roll-up shade 21 includes a section that generally corresponds to the surface of the window pane 17 and is approximated by essentially straight edges. The roll-up shade 21 is fixed at its bottom edge to a wind-up shaft 22 that is supported between wind-up shaft bearing arrangements so that it can rotate and move in the axial direction.

The edge of the roll-up shade 21 away from the wind-up shaft 22 forms a tubular loop 25, through which a pull-rod arrangement can be guided. Only the outer guide elements 26 of the pull-rod arrangement can be seen in FIG. 2. Each of the guide members 26 comprises a rod-like throat section 27, on whose free end a guide body 28 is formed. The guide members 26 can move back and forth in the axial direction relative to the throat section 27 in a tubular connecting piece of the pull-rod arrangement, which is located in the tubular loop 24.

To guide the roll-up shade 21 during its outwards movement, two guide rails 29 extend at the side next to the drawn out roll-up shade 21. Each guide rail 29 contains a groove chamber 30 that is continuous in the longitudinal direction, opens in the direction towards the roll-up shade 21 above a groove slot 31 and is circular in cross section. The width of the groove slot 31 corresponds to the dimension of the throat section 27 lying in this direction, while the guide body 28 is adapted in its dimensions and its cross-sectional shape to the groove chamber 30.

In the two groove chambers 30 of the two guide rails 29, associated coil-shaped, toothed pushing members 32 movable in the axial direction are provided. Each pushing member 32 consists of a cylindrical core 33 around which a raised coil 34 extends like a screw. The coil 34 forms a screw-like tooth running around the core 33. The pushing member 32 thus has the shape of a diagonally toothed flexible rod with circular cross section. The pushing members 32 are only very slightly resistant to bending, which is why they are guided resistant to buckling in the groove chamber 30.

A guide tube 35, which connects the groove chamber 30 of the associated guide rail 29 to a geared motor 36, connects to the bottom end of each guide rail 29. The geared motor 36 includes a permanently excited DC motor 37 that drives a gear train located in a gear housing 38. An output gear 40 is provided on an output shaft 39. The output gear 40 is shaped so that it can engage the toothing of the two pushing members 32 with a positive fit. So that the pushing members 32 cannot yield laterally, the pushing members 32 are guided in bores 41 that run tangentially past the output gear 40. The guide tubes 35 connect to these bores 41. Storage tubes can also be in the extension of the bores 41 in order to guide the inactive part of the pushing member in a controlled way.

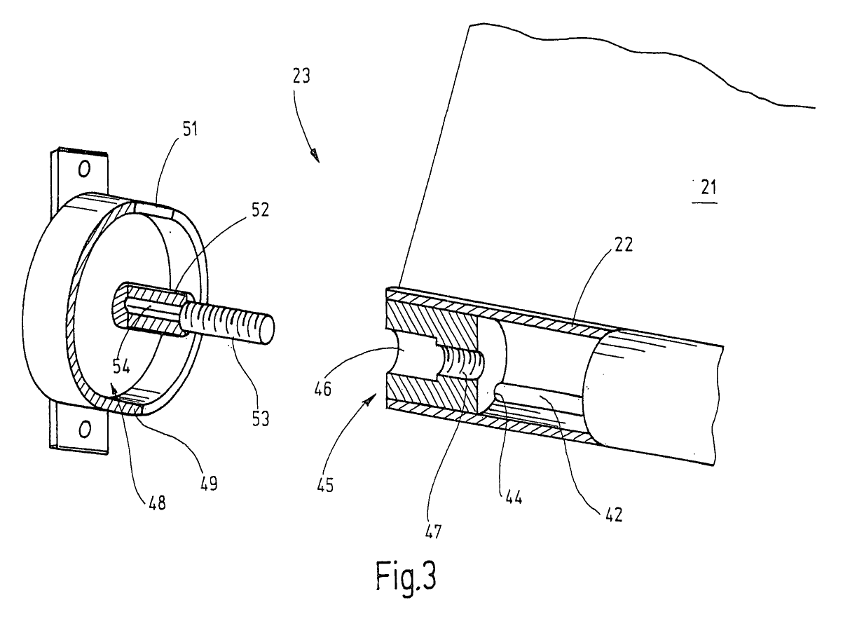

FIG. 3 illustrates the wind-up shaft bearing arrangement 23. As shown, the wind-up shaft 22 is a tubular part, from whose inner side a rib 42 raises. The rib 42 forms a piping groove on the outer side, in which the roll-up shade 21 is anchored in a known way. An insert 43 sits in the wind-up shaft on the associated end of this wind-up shaft 22. The insert 43 contains a lateral groove 44 that overlaps the rib 42 with a positive fit and thus simultaneously forms a rotation-fixing device relative to the wind-up shaft 22. The insert 43 cannot move in the axial direction. The insert 43 includes a coaxial stepped bore 45 coaxial to the wind-up shaft 22. An outer section 46 of the stepped bore 45 forms a smooth-walled cylindrical bearing bore 46. The cylindrical bearing bore 46 transitions an its inner end into a threaded bore 47, which is coaxial to the cylindrical bearing bore 46.

The wind-up shaft bearing arrangement 23 further includes a bearing plate 48, from which a short collar 49 projects in the direction towards the wind-up shaft 22. The collar 49 is broken at 51 and here forms a short slot, through which the roll-up shade 21 emerges. The bearing plate 48 carries a cylindrical tubular pin 52 with a cylindrical smooth outer surface. The outer diameter of the pin 52 is adapted to the cylindrical bearing bore 46. Therefore, the pin 52 can be used as a bearing journal for the cylindrical bearing bore 46. A threaded stem 53, whose thread fits the threaded bore 47, is anchored in the cylindrical pin 52 coaxially and in extended relation to the pin 52. The threaded stem 53 is extended on its rear side with a plug-in pin 54, with whose help the threaded stem 53 is locked in rotation in the bearing journal 52. Through back-cuts, the insert pin 45 can be locked in the bearing journal 52 or it is extrusion coated during the molding of the bearing plate 48 with the back-cuts being anchored in the plastic.

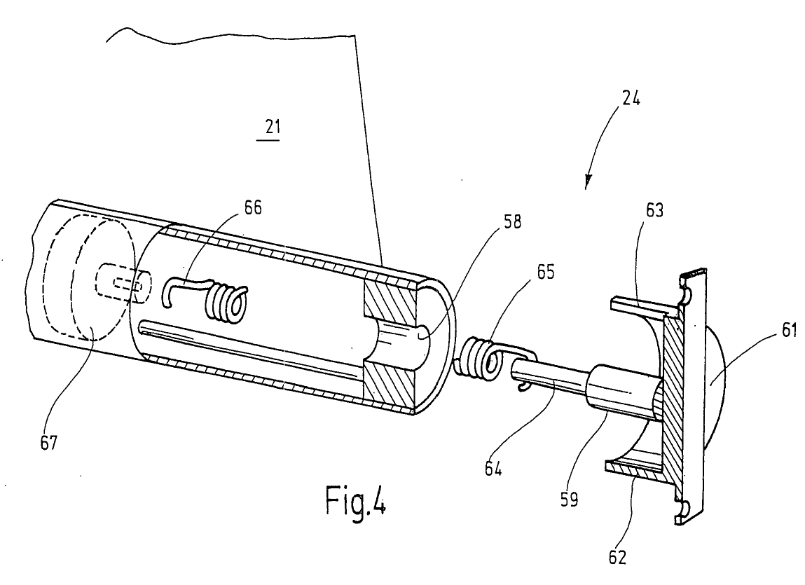

The wind-up shaft bearing arrangement 24 is shown in FIG. 4. The wind-up shaft bearing arrangement 24 includes a bearing bushing 57 that is fixed axially and inserted locked in rotation into the associated end of the wind-up shaft 22. The bearing bushing 57 contains a coaxial bearing bore 58. The bearing bore 58 interacts with a bearing stem 59 that is an integral component of a bearing plate 61. The bearing plate 61 is provided in a similar way with a collar 62 that includes a slot for the outlet of the roll-up shade 21 at 63. The bearing journal 59 is adapted in its outer diameter to the diameter of the bearing bore 58, in order to produce an essentially play-free bearing that is simultaneously also movable in the axial direction. The necessary length of the bearing journal 59 or the bearing bore 58 is apparent from the functional description provided below.

In the extension of the bearing journal 59, the bearing journal is provided coaxially with an anchoring pin 64 to which one end of a coil tension spring 65 is suspended. The other spring end 66 is anchored in a counter bearing 67 (shown with dashed lines) and contained in the wind-up shaft 22. The diameter of the bearing bore 58 is selected so that the coil spring 65 can be drawn out through the bearing bore 58, in order to suspend it in the locking pin 64 during installation. The coil spring 65 forms a spring motor.

The function of the arrangement described so far is as follows:

If the roll-up shade 21 is wound onto the wind-up shaft 22 to a maximum extent, the tubular loop 24 with the pull rod located therein is located approximately at the level of the bottom windowsill 19. In this position, for the wind-up shaft bearing arrangement 23, the end of the wind-up shaft 22 approaches the bearing plate 48 to a maximum extent, i.e., the rotationally fixed threaded stem 53 in this position is screwed into the threaded bore 47 up to a small residual distance depending on tolerances. The bearing bore 43 lies on the bearing journal 52 and can also guide the wind-up shaft 22.

In the area of the other wind-up shaft bearing arrangement 24, the wind-up shaft 22 is drawn downwards a large distance from the bearing journal 59. The bearing journal 59 and the bearing bore 58 cover only a small distance, viewed in the axial direction of the bearing journal 59. The length of the overlap is sufficient to achieve reliable rotational support of the wind-up shaft 22. The coil spring 65 forming the spring motor is not in tension up to a given residual stress, in order to generate, as before, a bias in the roll-up shade 21. In this position, the pushing members 32 are pulled back from the groove chambers 30.

Starting from this position, if the user sets the geared motor 36 in gear in order to extend the roll-up shade 21, the pushing members 32 are pushed into the groove chamber 30 by means of the positive-fit coupling between the output gear 40 and the pushing members 32. Here, the pushing members bump against the guide bodies 28 and push these forward. In this way, the roll-up shade 21 is pulled out from the interior of the door and set in tension fairly strongly in front of the window section 17.

The movement of the roll-up shade 21 results in a corresponding rotational movement of the wind-up shaft 22. Because the wind-up shaft 22 is coupled with the bearing plate 48 fixed in position in the door 7 by means of the threaded connection between the threaded stem 53 and the threaded bore 47, the wind-up shaft is moved in sync with the rotational movement axially away from the bearing plate 48. The wind-up shaft 22 is screwed down with its bearing part 43, as it were, by the threaded stem 53. It is understood that the insert 43 is anchored in the axial direction in the wind-up shaft 22, in order to transfer the axial movement forced on it also to the wind-up shaft 22.

When the roll-up shade 21 is completely extended, the threaded stem 53 projects a short distance into the threaded bore 57. The overlap is sufficient to realize proper screw engagement in the reverse movement, i.e., the overlap equals three to approximately seven turns according to the material type of the threaded bore 47 and the bearing journal 53. In addition, the bearing journal 52 also overlaps with the bearing bore 46, so that in the area of the wind-up shaft bearing arrangement 23, proper radial support of the wind-up shaft 22 is ensured.

In the area of the other wind-up shaft bearing arrangement 24, the wind-up shaft 22 is pushed onto the bearing journal 59 to a maximum extent and is at a minimum distance (dependent on tolerances) to the bearing plate 61. The coil spring 65 is extended to a maximum. Because it is embodied as a tension spring, the wind-up shaft 22 is pulled towards the bearing plate 61.

Those skilled in the art will understand that in order to create a side window roll-up shade whose wind-up shaft 22 does not move axially during the rotational movement it is sufficient to leave out the threaded stem 53. Through the effect of the coil spring 65, the wind-up shaft 22 is held constantly in a position touching the bearing plate 61, while it is supported on the pin 59 so that it can rotate. On the opposite end, the wind-up shaft 22 is supported exclusively by the interaction of the bearing bore 56 with the bearing journal 52 so that it can rotate.

No other illustration is necessary to see that the axial displacement of the wind-up shaft 22 could also be achieved if the bearing journal 59 of the bearing plate 61 is configured as a threaded stem, while the bearing bore 58 is a threaded bore. The threaded stem 53 on the other side of the wind-up shaft 22 would then naturally be eliminated. The function would otherwise be the same.

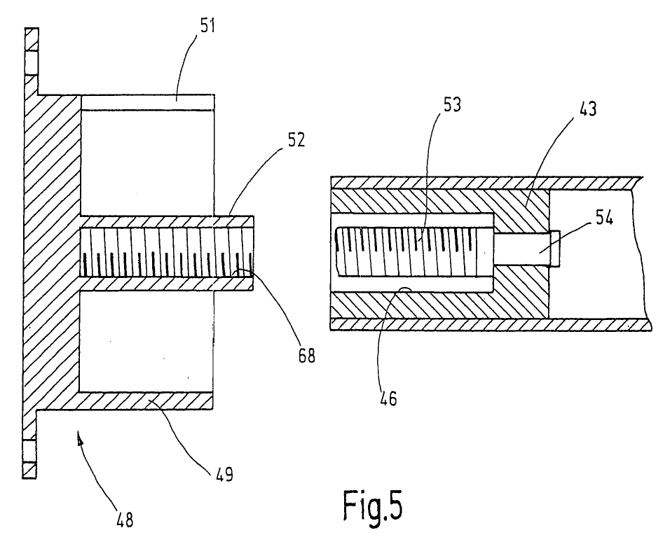

Another embodiment for the wind-up shaft bearing arrangement 23 is illustrated in FIG. 5. In this embodiment, the bearing journal 52 is configured as a hollow pin that contains a coaxial threaded bore 68, which functionally corresponds to the threaded bore 47 from FIG. 3. The insert 43 contains, as before, the bearing bore 46, in which the threaded stem 53 is housed coaxially. The threaded stem 53 is anchored locked in rotation with its plug-in pin 54 in a coaxial opening of the insert part 43. The advantage of this arrangement is that the thread of the pin 53 is protected in the bearing bore 46 and requires no additional axial space. Also, in this embodiment, by simply leaving out the threaded pin 53, a window roll-up shade can be produced that does not have axial movement of the wind-up shaft 22.

In all of the embodiments, the threaded stem responsible for the axial movement projects only somewhat into the wind-up shaft. In particular, it is possible to house the threaded stem outside of the wind-up shaft, so that, apart from the coil spring of the spring motor there are no other parts that extend over a long stretch through the wind-up shaft 22 and which can generate noise. The assembly is also further simplified, because those parts responsible for the axial movement are concentrated in the area of the associated end of the wind-up shaft and, apart from the tube of the wind-up shaft, otherwise have no connection to the other end of the wind-up shaft.

A side-window roll-up shade for passenger vehicle has bearing arrangements on both ends. One of the two bearing arrangements is provided with a threaded stem that extends over only a short distance of the wind-up shaft and which is anchored either in the wind-up shaft or in the car body. Thus, the assembly is limited to those parts responsible for the axial movement on the associated wind-up shaft end.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A side window roll-up shade assembly for a motor vehicle comprising:
a roll-up shade;
a pull-rod fixed to a first edge of the roll-up shade;
a wind-up shaft, the wind-up shaft being fixed to a second end of the roll-up shade and having first and second ends;
a spring motor for biasing the wind-up shaft in a wind-up direction;
a first wind-up shaft bearing arrangement for supporting the first end of the wind-up such that the wind-up shaft can perform rotational and translational movements; and
a second wind-up shaft bearing arrangement for supporting the second of the wind-up shaft such that the wind-up shaft can perform rotational and translational movements;
wherein the first or the second wind-up shaft bearing arrangement has a threaded stem and a threaded bore engageable with the threaded stem for enabling the wind-up shaft to make a translational movement as the wind-up shaft rotates about its longitudinal axis.

2. The side window roll-up shade according to claim 1, wherein the wind-up shaft is tubular.

3. The side window roll-up shade according to claim 2, wherein the spring motor includes a coil spring housed in the wind-up shaft.

4. The side window roll-up shade according to claim 1, wherein an end of the spring motor is anchored to the first or second wind-up shaft bearing arrangement.

5. The side window roll-up shade according to claim 3, wherein the interior of the coil spring is free.

6. The side window roll-up shade according to claim 3, wherein an inner end of the coil spring is connected to the wind-up shaft and an outer end of the coil spring is connected to the first wind-up shaft bearing arrangement.

7. The side window roll-up shade according to claim 1, wherein the first wind-up shaft bearing arrangement includes a bearing journal that is fixed in position and immovable in the motor vehicle.

8. The side window roll-up shade according to claim 7, wherein an outer end of a coil spring of the spring motor is anchored to the bearing journal.

9. The side window roll-up shade according to claim 7, wherein the threaded stem comprises the bearing journal of the first wind-up shaft bearing arrangement and the wind-up shaft contains the threaded bore.

10. The side window roll-up shade according to claim 9, wherein the second wind-up shaft bearing arrangement includes a cylindrical, smooth bearing journal that interacts with a cylindrical, smooth bearing bore, either the bearing journal or the bearing bore being fixed in position in the motor vehicle.

11. The side window roll-up shade according to claim 7, wherein the bearing journal of the first wind-up shaft bearing arrangement comprises a cylindrical, smooth bearing journal.

12. The side window roll-up shade according to claim 11, wherein the second wind-up shaft bearing arrangement includes a bearing journal that is embodied as the threaded stem.

13. The side window roll-up shade according to claim 12, wherein the threaded stem is fixed in position in the motor vehicle.

14. The side window roll-up shade according to claim 12, wherein the threaded stem is mounted so that it cannot move in the wind-up shaft.

15. The side window roll-up shade according to claim 12, wherein a cylindrical, smooth bearing journal is provided coaxial to the threaded stem.

16. The side window roll-up shade according to claim 1, wherein the threaded stem has a length that corresponds approximately to the axial stroke of the wind-up shaft with a minimum thread overlap with the threaded bore.

17. A side window roll-up shade for a motor vehicle comprising:
a roll-up shade
a pull-rod fixed to first edge of the roll-up shade;
a wind-up shaft fixed to a second edge of the roll-up shade, the wind-up shaft having first and second ends;
a spring motor for biasing the roll-up shaft in a wind-up direction;
a first wind-up shaft bearing arrangement for supporting the first end of the wind-up shaft and on which the spring motor is supported;
a second wind-up shaft bearing arrangement for supporting the second end of the wind-up shaft such that the wind-up shaft can perform rotational and translational movements;
wherein the second wind-up shaft bearing arrangement includes a cylindrical, smooth bearing journal, a bearing bore for the bearing journal, a seat for a threaded stem coaxial to the bearing journal, and a threaded bore for the threaded stem that is coaxial to the bearing bore such that the wind-up shaft can make translational movements only when the threaded stem is inserted while rotating about its longitudinal axis.
